(19) United States
(12) Patent Application Publication
(10) Pub. No.: US 2012/0254029 A1
(43) Pub. Date: Oct. 4, 2012

(54) MOTOR VEHICLE KEY AND METHOD FOR IMPLEMENTING A FINANCIAL TRANSACTION

(75) Inventors: Jeromy LAYNE, Mainz (DE); Joerg GSCHWENG, Mainz (DE)

(73) Assignee: GM GLOBAL TECHNOLOGY OPERATIONS LLC, Detroit, MI (US)

(21) Appl. No.: 13/415,917

(22) Filed: Mar. 9, 2012

(30) Foreign Application Priority Data
Mar. 10, 2011 (DE) 10 2011 013 598.7

(51) Int. Cl. G06Q 20/16; G06Q 20/36; G06Q 20/32

(52) U.S. Cl. 705/41

(57) ABSTRACT

A motor vehicle key is provided that includes, but is not limited to a closing device for cooperating with a motor vehicle lock, an electronic data memory for storing payment information, and a device for wireless transmission of payment information to an external receiver.

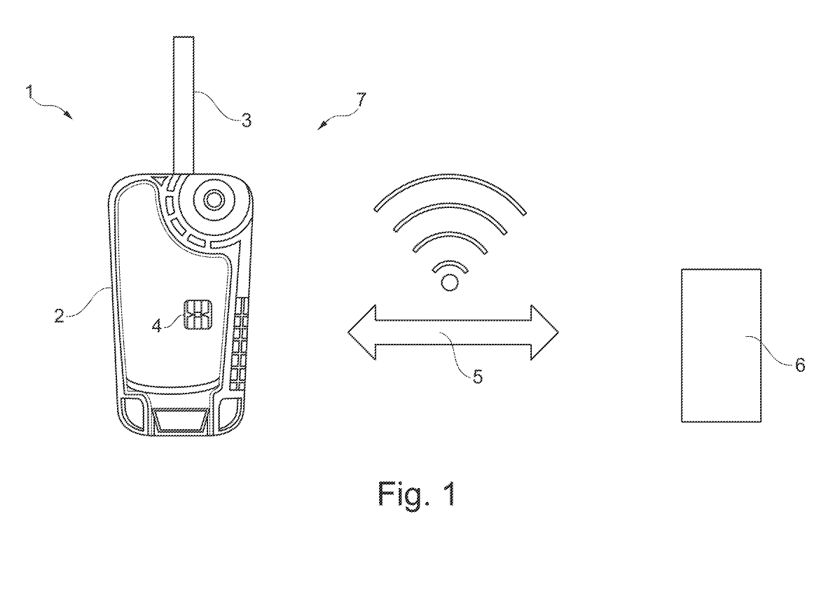

### CROSS-REFERENCE TO RELATED APPLICATION

This application claims priority to German Patent Application No. 10 2011 013 598.7, filed Mar. 10, 2011, which is incorporated herein by reference in its entirety.

### TECHNICAL FIELD

The technical field relates to a motor vehicle key, and further relates to a method for implementing a financial transaction with a motor vehicle key.

### BACKGROUND

It is known to fit mobile telephones with a payment function, which, for example, allows the simple and cash-free acquisition of electronic tickets. This payment function has the advantage that users are not dependent on carrying suitable amounts of cash and also no devices for accepting coins or notes need be held in readiness by a supplier of such a payment function.

Therefore, it is at least one object to provide an apparatus and a method that extend the possibilities for cashless payment in order to offer users a convenient method for cashless payment in particular of small amounts in everyday life. In addition, other objects, desirable features, and characteristics will become apparent from the subsequent summary and detailed description, and the appended claims, taken in conjunction with the accompanying drawings and this background.

### SUMMARY

According to an embodiment, a motor vehicle key is provided comprising a closing device for cooperating with a motor vehicle lock, an electronic data memory for storing payment information, and a device for wireless transmission of payment information to an external receiver. The closing device can be configured as an electronic closing device and/or as a mechanical closing device. Fitting a motor vehicle key with a payment function has the advantage that the user has linked a type of reserve amount of money to an everyday object, which he possibly carries with him every day. In this way, he has an amount of money accessible at any time, for example, for payment at a gas station.

In one embodiment, the device for wireless communication is designed for communication by means of NFC (near field communication). Such an NFC interface allows a data connection to be made rapidly and simply between the mobile motor vehicle key and a receiver. To this end, the motor vehicle key is brought into the near range, which is usually in the range of significantly less than one meter distance, of the receiver. The assignment of the two paired devices, motor vehicle key and receiver, is thus made by the user and need not be accomplished electronically. This enables a transaction to be implemented particularly rapidly. Communication via NFC is furthermore particularly energy-saving and is therefore very well suited for a battery-operated device such as a motor vehicle key.

Alternatively or additionally, the device for wireless communication can be designed for communication by means of Bluetooth. In this case, the Bluetooth interface provided can either be provided for use of Bluetooth Low Energy or conventional Bluetooth. According to one embodiment, the device for wireless communication is designed for communication by means of WLAN. In this context, communication by means of WLAN is understood as communication according to the IEEE 802.11 standard.

According to one embodiment, the method for implementing a financial transaction comprises taking a motor vehicle key which has an electronic data memory for storing payment information, into a receiving area of a receiver. A data connection is established between the receiver and the motor vehicle key and payment information in the electronic data storage device is read out by the receiver. A financial transaction is carried out between an account associated with the motor vehicle key and an account associated with the receiver.

Here and subsequently, a financial transaction is understood in this case as making an entry between two accounts, where the one account is associated with the motor vehicle key and the other account is associated with the receiver. This entry can be made in one direction or the other, i.e., money can be credited to the account associated with the motor vehicle key or money can be debited. Such financial transactions accordingly comprise both payment processes with the motor vehicle key and also loading an account associated with the motor vehicle key or withdrawing amounts of money by means of the motor vehicle key. The data connection is accomplished in a wireless manner, in particular via WLAN, Bluetooth and/or via NFC.

The motor vehicle key thereby acquires a money card function which enables a cashless offline payment. With this function, a transaction in particular of small amounts up to a few 100 Euro can be made very quickly and simply, possibly without any authentication of the user. Alternatively or additionally, a possibility for online payment can be provided where account information about an account to be debited by the financial transaction is stored in the electronic data memory for the storage of payment information. The term “debit” here and subsequently is intended to include a credit entry, also when typically when paying with the motor vehicle account key, a negative debiting of the account is made.

In one embodiment, information about a prepaid balance is stored in the electronic data memory for the storage of payment information. The payment information stored in the data memory, possibly account information for a direct debit process, a credit card number, a mobile phone number or similar allows the account to be debited to be identified without money on account needing to be paid in advance. An authentication of the user can thereby be provided.

According to one embodiment, a computer program product for implementing the method described for implementing a financial transaction is provided, when the computer program is executed on a processor unit or a controller.

### BRIEF DESCRIPTION OF THE DRAWINGS

The present invention will hereinafter be described in conjunction with the following drawing FIGURE, which shows schematically a motor vehicle key according to one embodiment.

### DETAILED DESCRIPTION

The following detailed description is merely exemplary in nature and is not intended to limit application and uses. Furthermore, there is no intention to be bound by any theory presented in the preceding background or summary or the following detailed description.

The motor vehicle key 1 comprises a housing 2 made of plastic in which various electronic devices of the motor vehicle key 1 are accommodated. In particular, a transponder can be provided in the housing 2 via which the motor vehicle key 1 communicates with the motor vehicle. In this way, an electronic closing device can be provided for opening and closing the motor vehicle locks. The motor vehicle key 1 further comprises a mechanical closing device 3 projecting from the housing 2 which can be inserted in a lock of the motor vehicle.

An NFC chip 4 is further located in the housing 2, which enables a radio connection to be established by means of the NFC (near field communication) transmission technique. An electronic data memory not shown in detail in the FIGURE, on which the payment information is stored, is located in the housing 2. The data memory can be integrated in the NFC chip 4. For example, information on a pre-paid credit balance or data to identify the owner of the motor vehicle key 1 can be stored in the electronic data memory.

In operation the motor vehicle key 1 is brought into the receiving range 7 of a receiver 6. When using NFC transmission technology, the receiving range 7 typically has an extension of several centimeters to a few tens of centimeters. In this way, unintentional connections are almost eliminated. When the motor vehicle key 1 is brought into the receiving range 7, the NFC chip is supplied with current by the receiver 6 and read out via a wireless data connection 5. The payment information stored in the electronic data memory is thereby read out during the payment process. The payment is confirmed by the user of the motor vehicle key 1, for example, by pressing a button.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle key, comprising:
a closing device that is configured to cooperate with a motor vehicle lock;
an electronic data memory that is configured to store payment information; and
a device that is configured to wireless transmit the payment information to an external receiver.

2. The motor vehicle key according to claim 1, wherein the closing device is configured as an electronic closing device.

3. The motor vehicle key according to claim 1, wherein the closing device is a mechanical closing device.

4. The motor vehicle key according to claim 1, wherein the device is configured to communicate via NFC.

5. The motor vehicle key according to claim 1, wherein the device is configured to communicate via Bluetooth.

6. The motor vehicle key according to claim 1, wherein the device is configured to communicate via a WLAN.

7. A method for implementing a financial transaction, comprising:
receiving a motor vehicle key including an electronic data memory that is configured to store payment information into a receiving area of a receiver;
establishing a data connection between the receiver and the motor vehicle key;
reading out the payment information in the electronic data memory by the receiver; and
carrying out the financial transaction between a first account associated with the motor vehicle key and a second account associated with the receiver.

8. The method according to claim 7, wherein the establishing the data connection is a wireless connection.

9. The method according to claim 8, wherein the establishing the data connection is established via WLAN.

10. The method according to claim 8, wherein the establishing the data connection is established via Bluetooth.

11. The method according to claim 8, wherein the establishing the data connection is established via NFC.

12. The method according to claim 7, further comprising storing information about a prepaid balance in the electronic data memory for storage of the payment information.

13. The method according to claim 7, further comprising storing account information about a third account to debit by the financial transaction in the electronic data memory for storage of the payment information.

14. A computer readable medium embodying a computer program product, said computer program product comprising:
a program for implementing a financial transaction, the program configured to:
receive a motor vehicle key including an electronic data memory that is configured to store payment information into a receiving area of a receiver;
establish a data connection between the receiver and the motor vehicle key;
read out the payment information in the electronic data memory by the receiver; and
carry out the financial transaction between a first account associated with the motor vehicle key and a second account associated with the receiver.

15. The computer readable medium embodying the computer program product according to claim 14, wherein the program is further configured to establish the data connection is a wireless connection.

16. The computer readable medium embodying the computer program product according to claim 14, wherein the program is further configured to establish the data connection is established via WLAN.

17. The computer readable medium embodying the computer program product according to claim 14, wherein the program is further configured to establish the data connection is established via Bluetooth.

18. The computer readable medium embodying the computer program product according to claim 14, wherein the program is further configured to establish the data connection is established via NFC.

19. The computer readable medium embodying the computer program product according to claim 14, wherein the program is further configured to store information about a prepaid balance in the electronic data memory for storage of the payment information.

20. The computer readable medium embodying the computer program product according to claim 14, wherein the program is further configured to store account information about a third account to debit by the financial transaction in the electronic data memory for storage of the payment information.
